(19) United States
(12) Patent Application Publication
(10) Pub. No.: US 2026/0299075 A1
(43) Pub. Date: Oct. 1, 2026

(54) RADIO PROPAGATION CHANNEL UPDATE

(71) Applicant: VIAVI Solutions Inc., Chandler, AZ (US)

(72) Inventors: Yilin JI, Stevenage (GB); Onur DIZDAR, London (GB); Stephen WANG, London (GB); Sohail TAHERI, Welwyn Garden City (GB)

(21) Appl. No.: 19/092,134

(22) Filed: Mar. 27, 2025

(51) Int. Cl. G01S 5/02; H04B 17/364; H04B 17/391

(52) U.S. Cl. CPC G01S 5/0273; G01S 5/0269; H04B 17/364; H04B 17/391

(57) ABSTRACT

In some implementations, a first snapshot may indicate a set of primitives including a transmitter at a first location, a receiver at a second location, and an object at a third location. A device may perform a geometric computation to determine a path extending from the first location to the third location and from the third location to the second location. An interaction point is at a fourth location corresponding to a position on the object at the third location. The device may determine a displacement associated with the object moving to a fifth location based on a second snapshot. The device may apply the displacement to the fourth location to determine a sixth location of the interaction point corresponding to the position on the object at the fifth location. The device may determine a second channel tap response based on a propagation distance associated with the path.

### BACKGROUND

Ray tracing is a propagation modeling approach for estimating characteristics of a ray considering any reflection, refraction, scattering, and/or diffraction of the ray that may be caused by objects within an environment via which the ray is transmitted. Ray tracing may be based on a light/wave duality principle. In accordance with the light/wave duality principle, at high frequencies, all of the physical properties applied to light (e.g., rays) can also be applied to waves (e.g., radio waves).

### SUMMARY

Some implementations described herein relate to a method. The method may include receiving a first snapshot of an environment, wherein the first snapshot is associated with a first time, wherein the first snapshot indicates a set of primitives within the environment, and wherein the set of primitives includes a transmitter located at a first location within the environment, a receiver located at a second location within the environment, and an object located at a third location within the environment. The method may include performing, based on the first snapshot, a geometric computation, to determine a plurality of paths associated with a ray traveling through the environment from the first location of the transmitter to the second location of the receiver, wherein the plurality of paths includes a non-line of sight (NLOS) path that extends from the first location of the transmitter to the third location of the object and from the third location of the object to the second location of the receiver, wherein a ray-primitive interaction point at which the ray interacts with the object is located at a fourth location, and wherein the fourth location corresponds to a fixed position on the object at the third location. The method may include performing, based on a result of performing the geometric computation, an electromagnetic computation to determine a first channel tap response. The method may include receiving a second snapshot of the environment, wherein the second snapshot is associated with a second time, wherein the second snapshot indicates the set of primitives within the environment, and wherein the object is located at a fifth location within the environment. The method may include determining a displacement associated with the object moving from the third location to the fifth location. The method may include applying the displacement to the fourth location of the ray-primitive interaction point to determine a sixth location, wherein the sixth location corresponds to the fixed position on the object at the fifth location. The method may include determining a total propagation distance associated with the NLOS path based on the fifth location and the sixth location. The method may include determining a second channel tap response based on the total propagation distance associated with the NLOS path. The method may include outputting information associated with the second channel tap response.

Some implementations described herein relate to a device. The device may include one or more memories and one or more processors coupled to the one or more memories. The one or more processors may be configured to receive a first snapshot of an environment, wherein the first snapshot is associated with a first time, wherein the first snapshot indicates a set of primitives within the environment, and wherein the set of primitives includes a transmitter located at a first location within the environment, a receiver located at a second location within the environment, and an object located at a third location within the environment. The one or more processors may be configured to perform, based on the first snapshot, a geometric computation, to determine a plurality of paths associated with a ray traveling through the environment from the first location of the transmitter to the second location of the receiver, wherein the plurality of paths includes an NLOS path that extends from the first location of the transmitter to the third location of the object and from the third location of the object to the second location of the receiver, wherein a ray-primitive interaction point at which the ray interacts with the object is located at a fourth location, and wherein the fourth location corresponds to a fixed position on the object at the third location. The one or more processors may be configured to perform, based on a result of performing the geometric computation, an electromagnetic computation to determine a first channel tap response. The one or more processors may be configured to receive a second snapshot of the environment, wherein the second snapshot is associated with a second time, wherein the second snapshot indicates the set of primitives within the environment, and wherein the object is located at a fifth location within the environment. The one or more processors may be configured to determine a displacement associated with the object moving from the third location to the fifth location. The one or more processors may be configured to apply the displacement to the fourth location of the ray-primitive interaction point to determine a sixth location, wherein the sixth location corresponds to the fixed position on the object at the fifth location. The one or more processors may be configured to determine a total propagation distance associated with the NLOS path based on the fifth location and the sixth location. The one or more processors may be configured to determine a second channel tap response based on the total propagation distance associated with the NLOS path. The one or more processors may be configured to output information associated with the second channel tap response.

Some implementations described herein relate to a non-transitory computer-readable medium that stores a set of instructions. The set of instructions, when executed by one or more processors of a device, may cause the device to receive a first snapshot of an environment, wherein the first snapshot is associated with a first time, wherein the first snapshot indicates a set of primitives within the environment, and wherein the set of primitives includes a transmitter located at a first location within the environment, a receiver located at a second location within the environment, and an object located at a third location within the environment. The set of instructions, when executed by one or more processors of the device, may cause the device to perform, based on the first snapshot, a geometric computation, to determine a plurality of paths associated with a ray traveling through the environment from the first location of the transmitter to the second location of the receiver, wherein the plurality of paths includes an NLOS path that extends from the first location of the transmitter to the third location of the object and from the third location of the object to the second location of the receiver, wherein a ray-primitive interaction point at which the ray interacts with the object is located at a fourth location, and wherein the fourth location corresponds to a fixed position on the object at the third location. The set of instructions, when executed by one or more processors of the device, may cause the device to perform, based on a result of performing the geometric computation, an electromagnetic computation to determine a first channel tap response. The set of instructions, when executed by one or more processors of the device, may cause the device to receive a second snapshot of the environment, wherein the second snapshot is associated with a second time, wherein the second snapshot indicates the set of primitives within the environment, and wherein the object is located at a fifth location within the environment. The set of instructions, when executed by one or more processors of the device, may cause the device to determine a displacement associated with the object moving from the third location to the fifth location. The set of instructions, when executed by one or more processors of the device, may cause the device to apply the displacement to the fourth location of the ray-primitive interaction point to determine a sixth location, wherein the sixth location corresponds to the fixed position on the object at the fifth location. The set of instructions, when executed by one or more processors of the device, may cause the device to determine a total propagation distance associated with the NLOS path based on the fifth location and the sixth location. The set of instructions, when executed by one or more processors of the device, may cause the device to determine a second channel tap response based on the total propagation distance associated with the NLOS path. The set of instructions, when executed by one or more processors of the device, may cause the device to output information associated with the second channel tap response.

### BRIEF DESCRIPTION OF THE DRAWINGS

FIGS. 1A-1E are diagrams of an example implementation associated with a radio propagation channel update procedure.

FIG. 2 is a diagram of an example environment in which systems and/or methods described herein may be implemented.

FIG. 3 is a diagram of example components of a device associated with a radio propagation channel update.

FIG. 4 is a flowchart of an example process associated with a radio propagation channel update.

### DETAILED DESCRIPTION

The following detailed description of example implementations refers to the accompanying drawings. The same reference numbers in different drawings may identify the same or similar elements.

A wireless communication system may use radio waves to transmit wireless communication signals between a transmitter (e.g., a device that transmits the wireless communication signal) and a receiver (e.g., a device that receives the wireless communication signal). In some cases, a propagation model (e.g., a set of equations and algorithms) may be used to estimate characteristics of a wireless communication signal based on parameters such as, for example, frequency, antenna height, properties of an environment through which the wireless communication signal is transmitted, and/or properties of one or more objects (e.g., buildings, vehicles, and/or the like) located within the environment.

Ray tracing may be a deterministic propagation model that utilizes details of an environment through which a ray travels to determine one or characteristics of the ray. For example, in some cases, the ray may comprise a wireless communication signal and the set of equations and algorithms of a ray tracing propagation model may be configured to estimate a path loss and phase change for the wireless communication signal while accounting for any reflection, refraction, scattering, and/or diffraction of the wireless communication signal that may be caused by objects within the environment via which the wireless communication signal is transmitted.

In some cases, ray tracing may comprise a geometric computation and an electromagnetic computation. The geometric computation may include determining a plurality of paths of a wireless communication signal from the transmitter to the receiver. In some cases, the geometric computation may determine the plurality of paths based on an individual ray (e.g., an individual wireless communication signal) that travels in a straight line through a homogenous medium, obeys the laws of reflection, refraction, and diffraction, and carries energy. In some cases, the geometric computation may further determine, for each of the plurality of paths, an angle of departure, an angle of arrival, and a propagation time (e.g., an amount of time for the wireless communication signal to travel from the transmitter to the receiver via the path).

In some cases, the paths may be predicted based on a snapshot. As used herein, a “snapshot” may refer to a set of data representing a depiction of an environment at a particular instant of time. In some cases, the depiction of the environment may include objects located within the environment. For example, at an instant of time, an environment may include a transmitter located at a first location, a building located at a second location, a vehicle located at a third location, and a receiver located at a fourth location. A snapshot of the environment at the first time may include a set of data indicating the transmitter located at the first location, the building located at the second location, the vehicle located at the third location, and the receiver located at the fourth location. A geometric computation based on the snapshot described above may include determining a plurality of paths that each have a starting point at a location of the transmitter (e.g., the first location) and an ending point at a location of the receiver (e.g., the fourth location).

In some cases, the depiction of the environment may include physical characteristics of the environment that may affect a propagation of the ray through the environment. For example, the environment may include a hill located between the transmitter and the receiver, a body of water that causes a deflection or diffraction of the ray, and/or a change in elevation that affects a line-of-sight (LOS) communication between the transmitter and the receiver, among other examples. In these cases, a snapshot of the environment may include a set of data representing the physical characteristics of the environment.

In some cases, the electromagnetic computation may include determining a tap response for each of the plurality of paths. In some cases, the tap response may include an estimated set of characteristics of the ray at the receiver. For example, the ray may correspond to a wireless communication signal and for each path, the electromagnetic computation may include estimating the characteristics of the wireless communication signal at a receiver based on the wireless communication signal traveling to the receiver via the path. In some cases, the tap response may include the mixing of wireless communication signals traveling different paths to simulate the effects of time in the mixing of multi-path signals.

In some cases, when there is an object (e.g., a transmitter, a receiver, and/or a vehicle, among other examples) moving within the environment, the propagation model may need to be updated (e.g., ray tracing may need to be re-performed) to account for a change of the location of the object within the environment. However, generating a new snapshot, performing a new geometric computation, and performing a new electromagnetic computation based on the new snapshot may be time consuming and/or computationally expensive and may not meet real-time or near-real-time requirements of an application in which ray tracing is being utilized.

In some cases, to reduce the amount of time and/or computation resources required to re-perform ray tracing, a virtual Doppler concept may be utilized to update the tap response determined for each path. The virtual Doppler concept may include deriving an additional phase shift based on a velocity (or the Doppler frequency) of each moving object and applying the additional phase shift to the previously determined tap response to determine an updated tap response. In this way, the virtual Doppler concept may enable the updated tap responses to be determined without having to perform a new geometric computation and/or a new electromagnetic computation, which may reduce the amount of time and computational resources relative to re-performing ray tracing.

However, the virtual Doppler concept may only be utilized for objects with linear motion (e.g., the virtual Doppler concept may require that the magnitude and direction of a velocity vector corresponding to the movement of the object must remain constant over subsequent snapshots). Stated differently, the virtual Doppler concept may be inapplicable in cases where an object moves with a variable velocity (e.g., a person that is carrying a transmitter or a receiver and that varies their pace as they walk down the street).

Further, velocity and the Doppler frequency are time dependent variables whereas ray tracing operates on the concept of snapshots. In particular, ray tracing operates on snapshots of the geometric description of all objects within the environment and the locations of the transmitter and the receiver. In some cases, translating between time (e.g., velocity and/or Doppler frequency associated with an object) and space (e.g., a geometric description of the object) may not be straightforward, which may increase the amount of time and/or computational resources required to utilize the virtual Doppler concept to update the tap responses.

Some implementations described herein relate to a ray tracing procedure that utilizes the locations of moving objects in the environment at times corresponding to each snapshot in conjunction with static bounce points to update the tap responses determined for the moving objects. In some aspects, a geometric and electromagnetic computation is performed based on a first snapshot corresponding to a geometric description of an environment at a first time. For each non-LOS (NLOS) path, a bounce point (e.g., a three-dimensional (3D) coordinate at which a ray strikes an object) is determined based on a result of performing the geometric computation. The bounce point for an object remains static (e.g., remains at the same relative position with respect to the object) as the location of the object changes over subsequent snapshots. For a second snapshot corresponding to a geometric description of the environment at a second time, a displacement of the object is computed with respect to the first snapshot. In some aspects, the displacement of the object is applied to the bounce point to determine a new location of the bounce point while enabling the bounce point to remain at the same relative position with respect to the object.

In some aspects, an updated total propagation distance may be determined for each path based on the new location of the object and the new location of the bounce point. In some aspects, an updated phase term may be determined based on the updated total propagation distance and an updated tap response may be determined based on the updated phase term.

In this way, the updated tap response may be determined without re-performing the geometric and electromagnetic computations. As a result, the amount of time and/or computational resources required to determine the updated tap responses may be reduced relative to re-performing the geometric and electromagnetic computations.

Further, updating the phase term based on the updated total propagation distance may account for the effect of the integration of velocity over time. Therefore, an updated tap response can be determined for objects with non-linear and/or arbitrary motion. Further, because the updated tap responses are determined based on a snapshot, the updated tap responses can be determined without performing any alignment in the time domain as is required when utilizing the virtual Doppler concept. Additionally, the locations of an object, a transmitter, and/or a receiver may be known (e.g., predetermined and/or otherwise provided to a device determining the tap responses), which may enable the updated tap responses to be determined based on data utilized to perform the initial ray tracing.

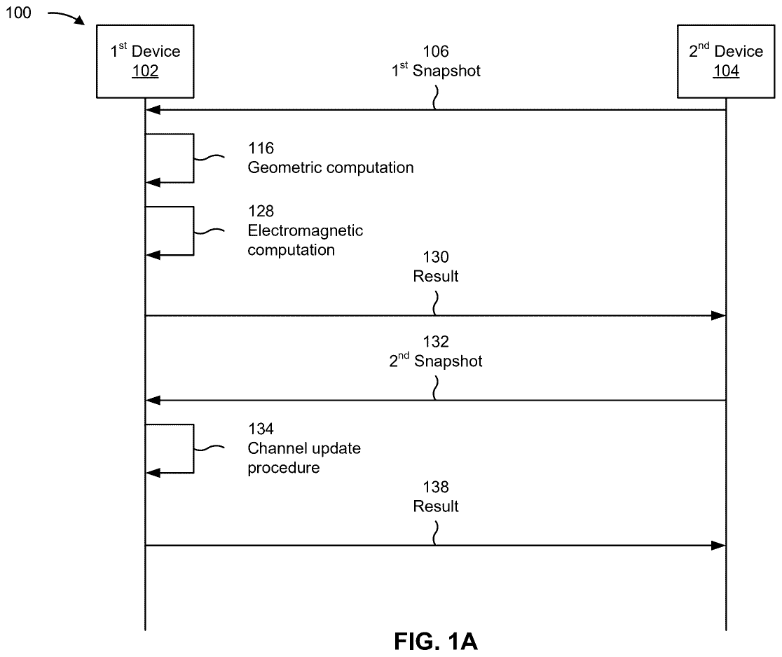

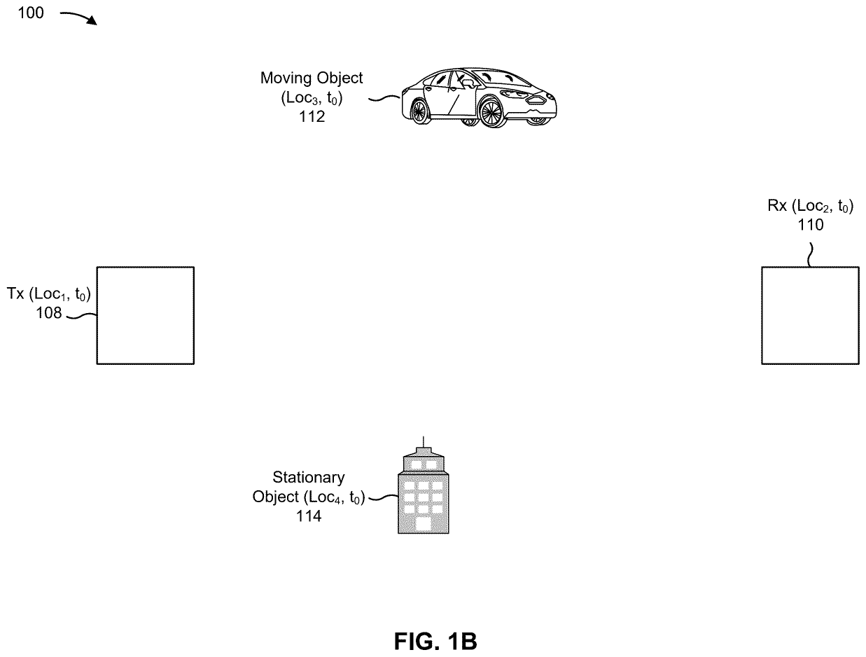

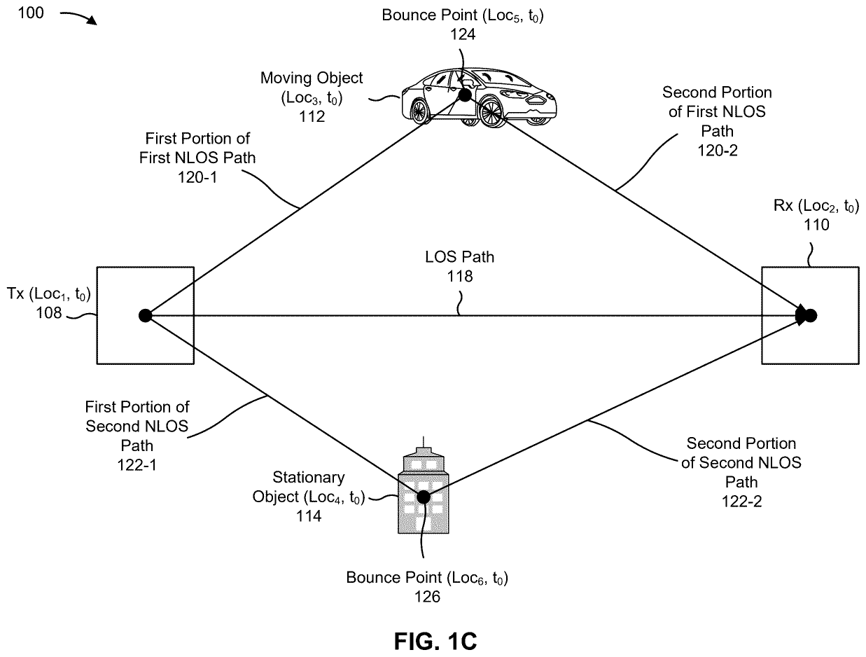

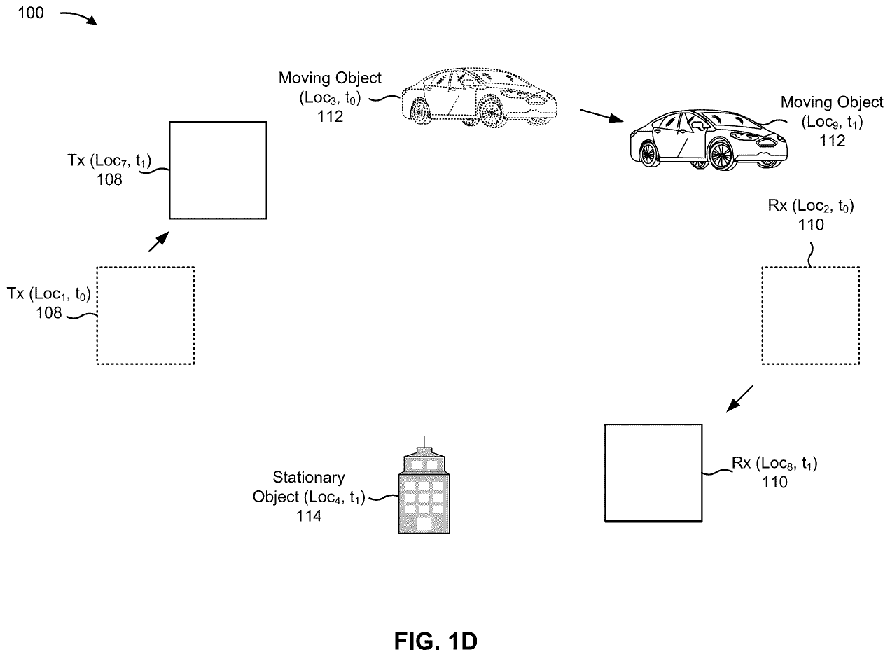

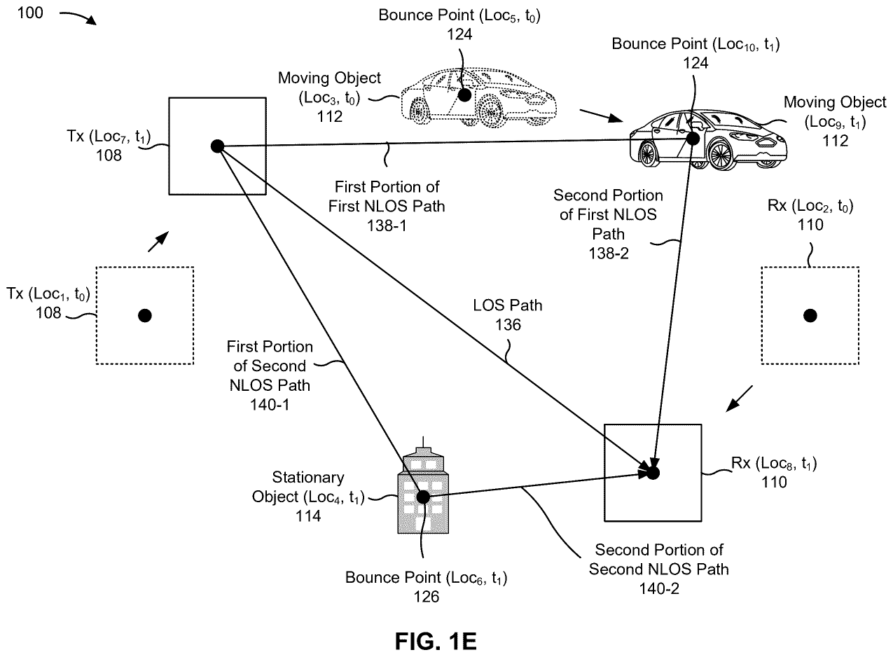

FIGS. 1A-1E are diagrams of an example implementation 100 associated with a radio propagation channel update procedure. As shown in FIG. 1A, example implementation 100 includes a first device 102 and a second device 104. In some aspects, the first device 102 and the second device 104 may be computing devices configured to perform one or more procedures described herein. For example, the first device 102 and/or the second device 104 may comprise a user equipment (UE), a network device, a test system, and/or a server device, among other examples.

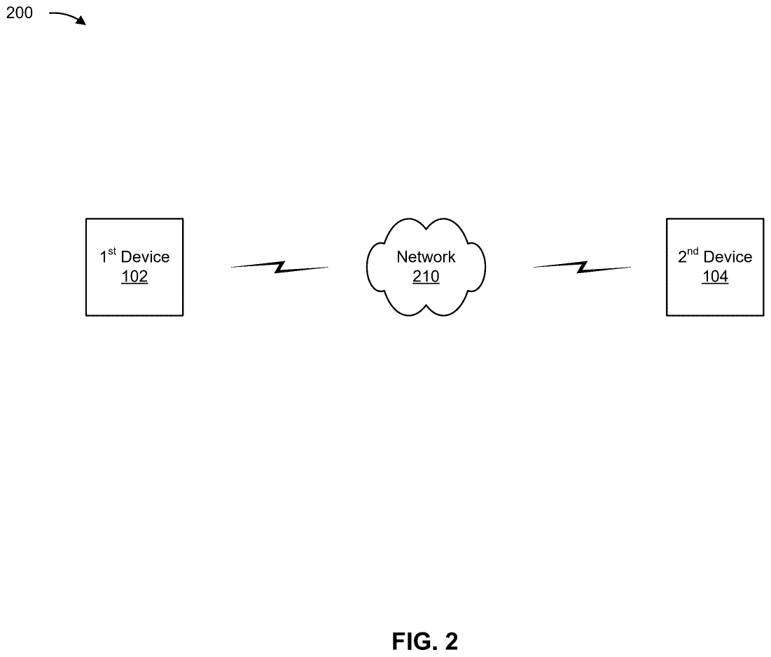

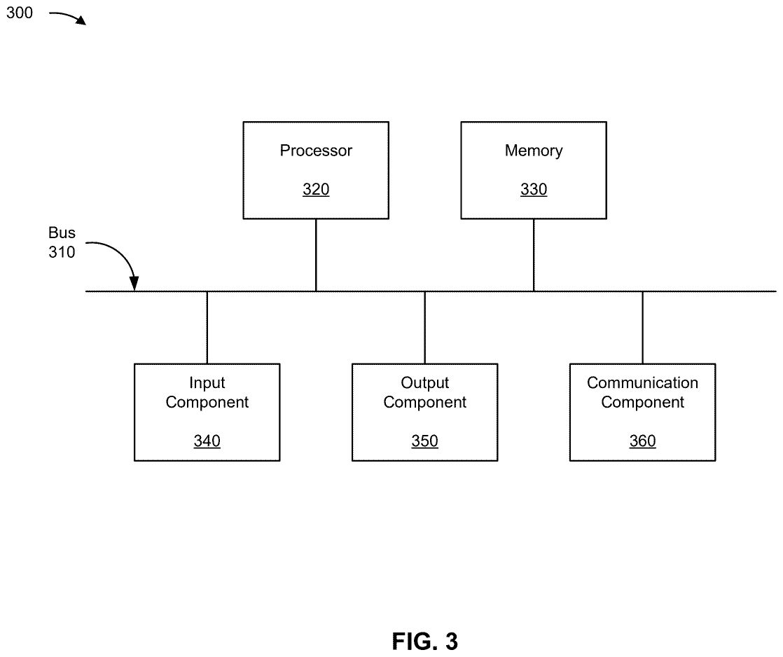

In some aspects, the first device 102 and the second device 104 may be associated with a same device. For example, the second device 104 may be an input device configured to enable a user to input information to the first device 102 and/or an output device configured to receive information from the first device 102 and to output the received information (e.g., for display and/or to another device). As another example, the first device 102 and the second device 104 may comprise different components of a same device. In some aspects, the first device 102 and the second device 104 may be separate devices. These devices are described in more detail below in connection with FIGS. 2 and 3.

As shown by reference number 106, the second device 104 may transmit, and the first device 102 may receive, data corresponding to a first snapshot of an environment. In some aspects, the first snapshot may be a set of data representing a depiction of a transmitter, a receiver, and a set of primitives within an environment at a first time. In some aspects, the transmitter and the receiver may be wireless communication devices such as a UE, a base station, an access point, a repeater, and/or another type of wireless communication device. In some aspects, the set of primitives may include geographical features (e.g., roads, hills, foliage, trees, lakes, rivers, oceans, and/or the like), stationary objects (e.g., buildings and/or other structures), and/or moving objects (e.g., a vehicle) located within the environment at the first time.

For example, as shown in FIG. 1B, at the first time (to), the environment may include a transmitter (Tx) 108 at a first location (Loc₁), a receiver (Rx) 110 at a second location (Loc₂), a moving object 112 at a third location (Loc₃), and a stationary object 114 at a fourth location (Loc₄). The first snapshot of the environment at the first time may include a set of data indicating the transmitter 108 located at the first location, the receiver 110 located at the second location, the moving object 112 located at the third location, and the stationary object 114 located at the fourth location. Although only a single moving object and a single stationary object are shown in FIG. 1B, in practice, the environment may include one or more geographical features, multiple moving objects, and/or multiple stationary objects.

In some aspects, locations (e.g., the first location, the second location, and/or the third location) indicated by a snapshot (e.g., the first snapshot and/or the second snapshot (described below)) may be indicated with respect to multiple dimensions. For example, a location may be represented as a set of coordinates with respect to an x-axis, a y-axis, and a z-axis and/or a set of coordinates indicating a latitude, longitude, and elevation corresponding to the location, among other examples.

In some aspects, the first snapshot may include data indicating a geometric description of one or more primitives within the environment at the first time. In some aspects, the geometric description may include one or more dimensions of a primitive. For example, the geometric description for a primitive may include an orientation of the primitive (or a surface of the primitive) with respect to the transmitter 108, an orientation of the primitive (or a surface of the primitive) with respect to the receiver 110, a total height of the primitive, a height of a portion (e.g., a surface) of the primitive, a total width of the primitive, a width of a portion of the primitive, a total depth of the primitive, and/or a depth of a portion of the primitive.

In some aspects, the first snapshot may include data indicating additional characteristics, properties, and/or features of a primitive. For example, the first snapshot may include data indicating a type or composition of a surface (e.g., glass, metal, plastic, or water, among other examples), a color, a density, and/or a refractive index, among other examples, of a primitive.

In some aspects, the first snapshot may include data indicating additional characteristics of the transmitter 108 and/or the receiver 110. For example, the first snapshot may include data indicating an antenna polarization type of an antenna of the transmitter 108 and/or the receiver 110, a transmit power at which the ray is transmitted, a quantity of antennas of the transmitter 108, a quantity of antennas of the receiver 110, and/or an modulation and coding scheme (MCS) associated with a transmission of the ray, among other examples.

As shown in FIG. 1A, and by reference number 116, the first device 102 may perform a geometric computation associated with the first snapshot of the environment. In some aspects, the geometric computation may include determining a plurality of paths that each have a starting point at a location of the transmitter (e.g., the first location) and an ending point at a location of the receiver (e.g., the second location). In some aspects, the first device 102 may include a propagation model that uses numerical simulations to predict the paths of a ray (e.g., a wireless communication signal) from the transmitter 108 to the receiver 110. In some aspects, for each path the propagation model may determine an angle of departure corresponding to an angle at which the ray is transmitted from the transmitter 108, an angle or arrival corresponding to an angle at which the ray is received by the receiver 110, and/or a propagation time corresponding to an amount of time required for the ray to travel from the transmitter 108 to the receiver 110 via the path.

In some aspects, the first device 102 may determine the plurality of paths based on a set of conditions. For example, the first device 102 may determine the plurality of paths based on an individual wireless communication signal that travels in a straight line through a homogeneous medium, obeys the laws of reflection, refraction, and diffraction, and carries energy. In some aspects, the first device 102 may treat a ray like a tube having an energy density on a cross section of the tube. In some aspects, the energy density may decrease as the ray interacts with the environment as the ray travels from the transmitter 108 to the receiver 110.

In some aspects, the plurality of paths may include one or more LOS paths and/or one or more NLOS paths. For example, as shown in FIG. 1C, the plurality of paths may include LOS path 118, a first NLOS path 120, and a second NLOS path 122. In some aspects, the LOS path 118 may be a path in which ray travels directly from the transmitter 108 to the receiver 110 (e.g., without reflecting off of a surface of an object).

In some aspects, an NLOS path (e.g., the first NLOS path 120 and/or the second NLOS path 122) may be a path in which the ray interacts with a surface of an object (e.g., moving object 112 and/or stationary object 114) prior to reaching the receiver 110. In some aspects, an interaction with a surface of an object may be a reflection, a refraction, a diffraction, or a scattering (e.g., a diffuse scattering).

A reflection may correspond to a ray reflecting off of a surface of an object according to the law of reflection. The law of reflection may be used to govern the behavior of a wireless communication signal as the wireless communication signal strakes a smooth, planar surface. In general, the law of reflection provides that when a ray (e.g., a wireless communication signal) reflects off of a surface, an angle at which the ray hits the surface (e.g., an angle of incidence) is equal to an angle at which the ray reflects off of the surface (e.g., an angle of reflection). The angle of incidence and the angle of reflection may be measured relative to a line that is perpendicular to the surface of the object at the point where the ray strikes the surface of the object. The point where the ray strikes the surface of the object may be referred to herein as a bounce point or a reflection point.

For example, as shown in FIG. 1C, a first portion of the first NLOS path 120-1 may correspond to a ray propagating from the transmitter 108 to the moving object 112 and a second portion of the first NLOS path 120-2 may correspond to the ray propagating from the moving object 112 to the receiver 110. The ray may strike and deflect off a surface of the moving object 112 at a bounce point 124. The bounce point 124 may be located at a location (e.g., L₅, as shown in FIG. 1C) on a surface of the moving object 112.

As another example, as also shown in FIG. 1C, a first portion of the second NLOS path 122-1 may correspond to a ray propagating from the transmitter 108 to the stationary object 114 and a second portion of the second NLOS path 122-2 may correspond to the ray propagating from the stationary object 114 to the receiver 110. The ray may strike and deflect off a surface of the stationary object 114 at a bounce point 126. The bounce point 126 may be located at a location (e.g., L₆, as shown in FIG. 1C) on a surface of the stationary object 114.

A refraction may correspond to a wireless communication signal refracting as the wireless communication signal moves into a new medium according to the law of refraction (also referred to as Snell's law). The law of refraction may be used to govern the behavior of a ray as the ray propagates across an interface (e.g., a boundary) between two dielectric media. For example, the law of refraction may be used to determine a path of a wireless communication signal as the wireless communication signal passes from air into glass or water. The law of refraction may provide that:

n₁ sinθ₁=n₂ sinθ₂,
where n₁ is a refractive index of a medium the wireless communication signal is exiting, n₂ is a refractive index of a medium the wireless communication signal is entering, θ₁ is the angle at which the wireless communication signal strikes the interface between the two media relative to a normal (e.g., perpendicular line) to the interface, and θ₂ is the angle subtended between the refracted wireless communication signal and the normal to the interface.

A diffraction may correspond to a wireless communication signal bending based on the wireless communication signal passing over an edge of a surface or spreading out based on the wireless communication signal passing through a small opening. Diffraction may occur when a size of the object or the opening is of the same order of magnitude as a wavelength of the wireless communication signal.

In some aspects, a diffraction may result in a ray spawning multiple diffracted rays. For example, for a ray passing through an opening that is smaller than the wavelength of the ray, the ray transmitted through the opening may spread out all the way around opening and may behave like of point source of rays.

A scattering may correspond to a ray interacting with a rough surface (e.g., a building façade, an ocean, and/or the like). Scattering may refer to a deviation of a straight line path of a ray that is caused by the wireless communication signal striking localized non-uniformities (including particles and radiation) in a surface of an object.

As shown in FIG. 1A, and by reference number 128, the first device 102 may perform an electromagnetic computation based on the geometric computation. In some aspects, the electromagnetic computation may include determining a tap response for the ray (e.g., a wireless communication signal) based on the geometric computation. For example, for each path, the electromagnetic computation may include estimating the characteristics of a wireless communication signal received by a receiver via the path. In some aspects, the tap response may include the mixing of wireless communication signal traveling different paths to simulate the effects of time in the mixing of the multipath signals.

In some aspects, the first device 102 may perform the electromagnetic computation based on a model of a baseband tap response of a multi-path communication channel. In some aspects, the model of the baseband tap response of the multi-path communication channel may be expressed as:

$$h ( t , τ ) = {\sum }_{l = 1}^{L ( t )} {α}_{l} ( t ) * exp ( - j 2 π {f}_{c} {τ}_{l} ( t ) ) * δ ( τ - {τ}_{l} ( t ) ) , \qquad ( 1 )$$

where τ is the time domain, τ is the delay domain, l is the path index, L(t) is the time-variant total number of paths, αₗ(t) is the time-variant complex amplitude, τₗ(t) is the tap delay of the l-th path, f_{c} is the center frequency, δ(·) is the Dirac delta function, and exp(·) is the exponential constant.

In some aspects, the time-variant complex amplitude (αₗ(t)) may indicate or describe a combined effect of the path loss and scattering coefficients (e.g., multi-bounce scattering coefficients). In some aspects, the exponential term (exp (−j2πf_{c}τₗ(t))) may indicate or describe a phase shift associated with a delay at the center frequency. In some aspects, the delta term (δ(τ−τₗ(t) may indicate or describe a tap location in a delay domain.

In some aspects, the first device 102 may modify the model of the baseband tap response of the multi-path communication channel based on one or more determinations, assumptions, and/or conditions. For example, the first device 102 may modify the model of the baseband tap response of the multi-path communication channel based on determining (or assuming) that, for a relatively short time (t), where t ∈ [t₀, t_{T}]:
a change in the time-variant complex amplitude is negligible (e.g., less than a threshold) and, therefore, αₗ(t)=αₗ(t₀),
a change in the time-variant total number of paths is negligible (e.g., less than a threshold) and, therefore, L(t)=L(t₀),
a change in the tap location in the delay domain is negligible (e.g., less than a threshold) based on the delay resolution (or bandwidth) of the transmit signal and, therefore, δ(τ−τₗ(t)=δ(τ−τₗ(t₀), and/or,
a change in the exponential term is significant (e.g., greater than a threshold) based on the wave period (1/f_{c}) being on a same order of magnitude, or smaller than, the duration (τ_{T}−t₀).

In some aspects, the first device 102 may modify the model of the baseband tap response of the multi-path communication channel based on the determinations listed above. In these aspects, the modified model of the baseband tap response of the multi-path communication channel may be represented by the following equation:

$$h ( t , τ ) = {\sum }_{l = 1}^{L ( {t}_{0} )} {α}_{l} ( {t}_{0} ) * exp ( - j 2 π {f}_{c} {τ}_{l} ( t ) ) * δ ( τ - {τ}_{l} ( {t}_{0} ) ) , t ∈ [ {t}_{0} , {t}_{T} ] . \qquad ( 2 )$$

In the equation representing the modified model, only the exponential term (exp(−j2πf_{c}τₗ(t))) is time-variant. In some aspects, the exponential term can be represented as:

$$exp ( - j 2 π {f}_{c} {τ}_{l} ( t ) ) = exp ( - \frac{j 2 π {f}_{c} {d}_{l} ( t )}{c} ) , \qquad ( 3 )$$

where dₗ(t) is a total propagation distance of the l-th path, and c is the speed of light.

In some aspects, the first device 102 may determine a set of parameters (e.g., L(t₀), αₗ(t₀), Tₗ(t₀), and dₗ(t₀)) and/or positions of all ray-primitive interaction points (e.g., bounce points 124, 126) based on performing the geometric computation. In some aspects, the first device 102 may perform the electromagnetic computation based on the determined set of parameters and/or the positions of all the ray-primitive interaction points. For example, the first device 102 may utilize the set of parameters and the positions of all of the ray-primitive interaction points to determine the channel tap response h(t₀, τ) utilizing the equation representing the modified model (e.g., equation (2)).

As shown by reference number 130, the first device 102 may transmit, and the second device 104 may receive, information associated with a result of performing the geometric computation and/or the electromagnetic computation. For example, the first device 102 may transmit information indicating the set of parameters, the ray-primitive interaction points, and/or the channel tap response, among other examples, to the second device 104 to cause the second device 104 to provide the set of parameters, the ray-primitive interaction points, and/or the channel tap response for display to a user.

As shown by reference number 132, the second device 104 may transmit, and the first device 102 may receive, data corresponding to a second snapshot of the environment. In some aspects, the second snapshot of the environment may be a set of data representing a depiction of the transmitter, the receiver, and a set of primitives within the environment at a second time that is subsequent to the first time.

In some aspects, the set of primitives within the environment at the second time may be the same as the set of primitives within the environment at the first time. In some aspects, the set of primitives within the environment at the second time may include one or more primitives that were not within the environment at the first time. In some aspects, the set of primitives within the environment at the second time may not include one or more primitives within the environment at the first time.

In some aspects, a location of a primitive within the environment at the first time may be the same or different from a location within the environment at the second time. For example, as shown in FIG. 1D, at the second time (t₁), the transmitter (Tx) 108 may be located at a seventh location (Loc₇) that is different from the first location (Loc₁), the receiver (Rx) 110 may be located at a eighth location (Loc₈) that is different from the second location (Loc₂), the moving object 112 may be located at a ninth location (Loc₉) that is different from the third location (Loc₃), and the stationary object 114 may be located at a same location (e.g., the fourth location (Loc₄)). The second snapshot of the environment at the second time may include a set of data indicating the transmitter 108 located at the fifth location, the receiver 110 located at the sixth location, the moving object 112 located at the seventh location, and the stationary object 114 located at the fourth location.

In some aspects, the second snapshot may include data indicating a geometric description of one or more primitives within the environment at the second time. In some aspects, the geometric description of the one or more primitives within the environment at the second time may be similar to the geometric description of the one or more primitives included in the first snapshot, described above.

In some aspects, the second snapshot may include data indicating additional characteristics, properties, and/or features of a primitive. In some aspects, the data indicating additional characteristics, properties, and/or features of a primitive may be similar to the data indicating additional characteristics, properties, and/or features of a primitive included in the first snapshot, described above.

In some aspects, the second snapshot may include data indicating additional characteristics of the transmitter 108 and/or the receiver 106. In some aspects, the data indicating additional characteristics of the transmitter 108 and/or the receiver 106 may be similar to data indicating the additional characteristics of the transmitter 108 and/or the receiver 106 included in the first snapshot, described above.

As shown in FIG. 1A, and by reference number 134, the first device 102 may perform a channel update procedure based on the second snapshot of the environment. In some aspects, the channel update procedure may include determining a location of each primitive included in the set of primitives at the second time. For example, based on the data corresponding to the second snapshot, the first device 102 may determine that, at the second time (t₁), the transmitter (Tx) 108 is located at the seventh location (Loc₇), the receiver (Rx) 110 is located at the eighth location (Loc₈), the moving object 112 is located at the ninth location (Loc₉), and the stationary object 114 is located at the fourth location (Loc₄).

In some aspects, the channel update procedure may include determining, for each primitive included in the set of primitives, a displacement within the environment based on the location of the primitive within the environment at the first time and the location of the primitive within the environment at the second time. As an example, the location of the moving object 112 at the first time may be represented as (x₁, y₁, z₁) and the location of the moving object 112 at the second time may be represented as (x₂, y₂, z₂). The first device 102 may determine a displacement within the environment for the moving object 112 as (x₂-x₁, y₂-y₁, z₂-z₁).

As another example, the location of the stationary object 114 at the first time may be represented as (x₃, y₃, z₃) and the location of the stationary object 114 at the second time may also be represented as (x₃, y₃, z₃) based on the stationary object 114 remaining at the same location. The first device 102 may determine a displacement within the environment for the stationary object 114 as (x₃-x₃, y₃-y₃, z₃-z₃) or (0, 0, 0).

In some aspects, the channel update procedure may include applying the displacement determined for each primitive to the location of the ray-primitive interaction point to determine a location of the ray-primitive interaction point at the second time. Continuing with the example described above with respect to the moving object 112, the first device 102 may apply the displacement determined for the moving object 112 to the location of the bounce point 124 at the first time to determine the location of bounce point 124 at the second time (e.g., Loc₁₀, as shown in FIG. 1E).

Continuing with the example described above with respect to the stationary object 114, the first device 102 may apply the displacement determined for the stationary object 114 to the location of the bounce point 126 at the first time to determine that the location of the bounce point 126 at the second time (e.g., Loc₆, as shown in FIG. 1E) is the same as the location of the bounce point 126 at the first time (e.g., Loc₆, as shown in FIG. 1C).

In some aspects, the channel update procedure may include determining, for each path of a plurality of paths, a respective total propagation distance (d₁(t₁)) of the path based on the locations of the transmitter 108, the receiver 110, and the ray-primitive interaction points (e.g., bounce points 124, 126) at the second time. For example, as shown in FIG. 1E, the plurality of paths may include a LOS path 136 from the transmitter 108 to the receiver 110, a first NLOS path 138 that includes a first portion 138-1 that extends from the location of the transmitter 108 to the location of the bounce point 124 and a second portion 138-2 that extends from the location of the bounce point 124 to the location of the receiver 110, and a second NLOS path 140 that includes a first portion 140-1 that extends from the location of the transmitter 108 to the location of the bounce point 126 and a second portion 140-2 that extends from the location of the bounce point 126 to the location of the receiver 110.

In some aspects, the channel update procedure may include determining an updated phase term based on the respective total propagation distance (dₗ(t₁)) determined for each path. In some aspects, the first device 102 may determine the updated phase term using equation 3, described above, and the respective total propagation distance (dₗ(t₁)) determined for each path.

In some aspects, the channel update procedure may include determining an updated channel tap response h(t₁, τ) based on the updated phase term. In some aspects, the first device 102 may determine the updated channel tap response using equation 2, described above, and the updated phase term.

As shown in FIG. 1A, and by reference number 138, the first device 102 may transmit a result of performing the channel update procedure based on the second snapshot of the environment. In some aspects, the first device 102 may transmit the result of performing the channel update procedure based on the second snapshot of the environment in a manner similar to that described above with respect to reference number 130.

In this way, the channel update procedure may conserve computation resources relative to performing geometric and electromagnetic computations for the second snapshot. Further, because the term dₗ(t) in equation 3 accounts for the effect of the integration of the velocity of an object over time, the channel update procedure supports non-linear and arbitrary motions of moving objects within the environment. Additionally, the channel update procedure is synchronized with the snapshot of the environment thereby eliminating the need to perform any alignment in the time domain.

As indicated above, FIGS. 1A-1E are provided as an example. Other examples may differ from what is described with regard to FIGS. 1A-1E. The number and arrangement of devices shown in FIGS. 1A-1E are provided as an example. In practice, there may be additional devices, fewer devices, different devices, or differently arranged devices than those shown in FIGS. 1A-1E. Furthermore, two or more devices shown in FIGS. 1A-1E may be implemented within a single device, or a single device shown in FIGS. 1A-1E may be implemented as multiple, distributed devices. Additionally, or alternatively, a set of devices (e.g., one or more devices) shown in FIGS. 1A-1E may perform one or more functions described as being performed by another set of devices shown in FIGS. 1A-1E.

FIG. 2 is a diagram of an example environment 200 in which systems and/or methods described herein may be implemented. As shown in FIG. 2, environment 200 may include a first device 102, a second device 104, and a network 210. Devices of environment 200 may interconnect via wired connections, wireless connections, or a combination of wired and wireless connections.

The first device 102 includes one or more devices capable of a radio channel propagation update based on a snapshot of an environment, as described herein. In some aspects, the first device 102 may include a communication and/or computing device, such as a mobile phone (e.g., a smart phone, a radiotelephone, etc.), a laptop computer, a tablet computer, a handheld computer, a desktop computer, a gaming device, a wearable communication device (e.g., a smart wristwatch, a pair of smart eyeglasses, etc.), or a similar type of device.

The second device 104 may include one or more devices capable of communicating with the first device 102 and/or a network (e.g., network 210). For example, the second device 104 may include a wireless communication device, a radiotelephone, a personal communications system (PCS) terminal (e.g., that may combine a cellular radiotelephone with data processing and data communications capabilities), a smart phone, a laptop computer, a tablet computer, a personal gaming system, user equipment, and/or a similar device. The second device 104 may be capable of communicating using uplink (e.g., UE to base station) communications, downlink (e.g., base station to UE) communications, and/or sidelink (e.g., UE-to-UE) communications.

Network 210 includes one or more wired and/or wireless networks. For example, network 210 may include a cellular network (e.g., a long-term evolution (LTE) network, a code division multiple access (CDMA) network, a 3G network, a 4G network, a 5G network, or another type of next generation network), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, and/or a combination of these or other types of networks.

The quantity and arrangement of devices and networks shown in FIG. 2 are provided as one or more examples. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with a radio propagation channel update. The device 300 corresponds to one or more of an first device 102 and/or a second device 104. In some implementations, the first device 102 and/or the second device 104 include one or more devices 300 and/or one or more components of the device 300. In the example shown in FIG. 3, the device 300 includes a bus 310, a processor 320, a memory 330, an input component 340, an output component 350, and/or a communication component 360.

The bus 310 includes one or more components that enable wired and/or wireless communication among the components of the device 300. The bus 310 couples together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 includes a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory, such as random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). In some implementations, the memory 330 is a non-transitory computer-readable medium. The memory 330 stores information, one or more instructions, and/or software (e.g., one or more software applications) related to the operation of the device 300. In some implementations, the memory 330 includes one or more memories that are coupled (e.g., communicatively coupled) to one or more processors (e.g., processor 320), such as via the bus 310. Communicative coupling between a processor 320 and a memory 330 enables the processor 320 to read and/or process information stored in the memory 330 and/or to store information in the memory 330.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

In some implementations, the device 300 performs one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry is used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

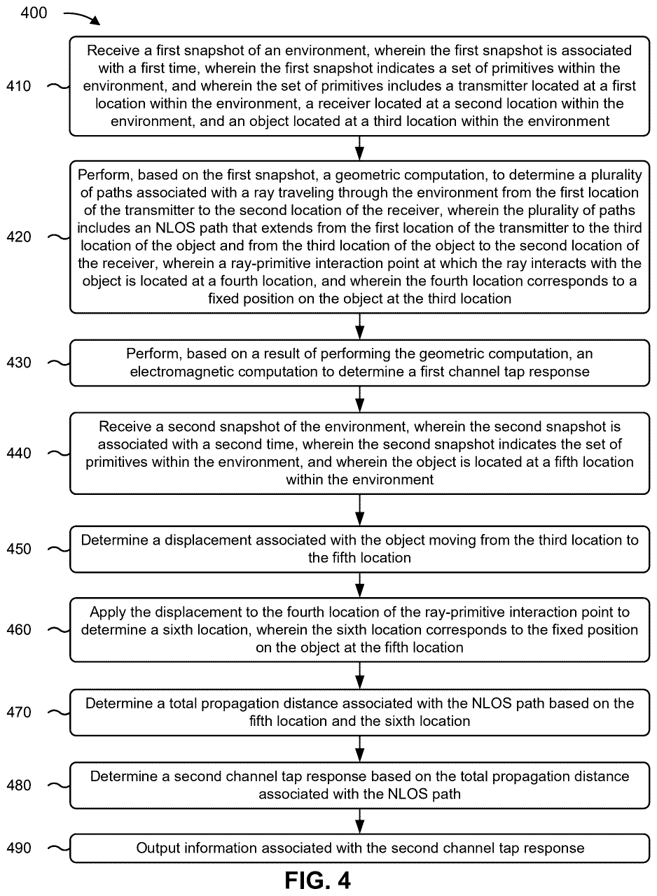

FIG. 4 is a flowchart of an example process 400 associated with a radio propagation channel update. One or more process blocks of FIG. 4 are performed by a device (e.g., a first device 102) and/or by another device or a group of devices separate from or including the device, such as a second device (e.g., a second device 104). Additionally, or alternatively, one or more process blocks of FIG. 4 may be performed by one or more components of device 300, such as processor 320, memory 330, input component 340, output component 350, and/or communication component 360.

As shown in FIG. 4, process 400 includes receiving a first snapshot of an environment, wherein the first snapshot is associated with a first time, wherein the first snapshot indicates a set of primitives within the environment, and wherein the set of primitives includes a transmitter located at a first location within the environment, a receiver located at a second location within the environment, and an object located at a third location within the environment (block 410). For example, the device may receive a first snapshot of an environment, wherein the first snapshot is associated with a first time, wherein the first snapshot indicates a set of primitives within the environment, and wherein the set of primitives includes a transmitter located at a first location within the environment, a receiver located at a second location within the environment, and an object located at a third location within the environment, as described above.

As further shown in FIG. 4, process 400 includes performing, based on the first snapshot, a geometric computation, to determine a plurality of paths associated with a ray traveling through the environment from the first location of the transmitter to the second location of the receiver, wherein the plurality of paths includes an NLOS path that extends from the first location of the transmitter to the third location of the object and from the third location of the object to the second location of the receiver, wherein a ray-primitive interaction point at which the ray interacts with the object is located at a fourth location, and wherein the fourth location corresponds to a fixed position on the object at the third location (block 420). For example, the device may perform, based on the first snapshot, a geometric computation, to determine a plurality of paths associated with a ray traveling through the environment from the first location of the transmitter to the second location of the receiver, wherein the plurality of paths includes an NLOS path that extends from the first location of the transmitter to the third location of the object and from the third location of the object to the second location of the receiver, wherein a ray-primitive interaction point at which the ray interacts with the object is located at a fourth location, and wherein the fourth location corresponds to a fixed position on the object at the third location, as described above.

As further shown in FIG. 4, process 400 includes performing, based on a result of performing the geometric computation, an electromagnetic computation to determine a first channel tap response (block 430). For example, the device may perform, based on a result of performing the geometric computation, an electromagnetic computation to determine a first channel tap response, as described above.

As further shown in FIG. 4, process 400 includes receiving a second snapshot of the environment, wherein the second snapshot is associated with a second time, wherein the second snapshot indicates the set of primitives within the environment, and wherein the object is located at a fifth location within the environment (block 440). For example, the device may receive a second snapshot of the environment, wherein the second snapshot is associated with a second time, wherein the second snapshot indicates the set of primitives within the environment, and wherein the object is located at a fifth location within the environment, as described above.

As further shown in FIG. 4, process 400 includes determining a displacement associated with the object moving from the third location to the fifth location (block 450). For example, the device may determine a displacement associated with the object moving from the third location to the fifth location, as described above.

As further shown in FIG. 4, process 400 includes applying the displacement to the fourth location of the ray-primitive interaction point to determine a sixth location, wherein the sixth location corresponds to the fixed position on the object at the fifth location (block 460). For example, the device may apply the displacement to the fourth location of the ray-primitive interaction point to determine a sixth location, wherein the sixth location corresponds to the fixed position on the object at the fifth location, as described above.

As further shown in FIG. 4, process 400 includes determining a total propagation distance associated with the NLOS path based on the fifth location and the sixth location (block 470). For example, the device may determine a total propagation distance associated with the NLOS path based on the fifth location and the sixth location, as described above.

As further shown in FIG. 4, process 400 includes determining a second channel tap response based on the total propagation distance associated with the NLOS path (block 480). For example, the device may determine a second channel tap response based on the total propagation distance associated with the NLOS path, as described above.

As further shown in FIG. 4, process 400 includes outputting information associated with the second channel tap response (block 490). For example, the device may output information associated with the second channel tap response, as described above.

Process 400 may include additional aspects, such as any single aspect or any combination of aspects described below and/or in connection with one or more other processes described elsewhere herein.

In a first aspect, process 400 includes determining a phase term based on the total propagation distance, wherein the second channel tap response is determined based on the phase term.

In a second aspect, alone or in combination with the first aspect, one or more subsequent channel tap responses are determined based on the ray-primitive interaction point being located at the fixed position on the object.

In a third aspect, alone or in combination with one or more of the first and second aspects, the electromagnetic computation is performed based on a determination that a change in a time-variant complex amplitude over a time period is less than a threshold.

In a fourth aspect, alone or in combination with one or more of the first through third aspects, the electromagnetic computation is performed based on a determination that a change in a time-variant total quantity of paths over a time period is less than a threshold.

In a fifth aspect, alone or in combination with one or more of the first through fourth aspects, the electromagnetic computation is performed based on a determination that a change in a tap location in a delay domain over a time period is less than a threshold.

In a sixth aspect, alone or in combination with one or more of the first through fifth aspects, process 400 includes determining that the change in the tap location in the delay domain over the time period is less than the threshold based on a delay resolution or a bandwidth associated with the ray traveling through the environment.

In a seventh aspect, alone or in combination with one or more of the first through sixth aspects, the electromagnetic computation is performed based on a determination that a difference, over a time period, in an exponential term used to determine the first channel tap response is greater than a threshold.

In an eighth aspect, alone or in combination with one or more of the first through seventh aspects, the ray corresponds to a wireless communication signal.

Although FIG. 4 shows example blocks of process 400, in some implementations, process 400 includes additional blocks, fewer blocks, different blocks, or differently arranged blocks than those depicted in FIG. 4. Additionally, or alternatively, two or more of the blocks of process 400 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of”′ a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method comprising:
receiving a first snapshot of an environment, wherein the first snapshot is associated with a first time, wherein the first snapshot indicates a set of primitives within the environment, and wherein the set of primitives includes a transmitter located at a first location within the environment, a receiver located at a second location within the environment, and an object located at a third location within the environment;
performing, based on the first snapshot, a geometric computation, to determine a plurality of paths associated with a ray traveling through the environment from the first location of the transmitter to the second location of the receiver, wherein the plurality of paths includes a non-line of sight (NLOS) path that extends from the first location of the transmitter to the third location of the object and from the third location of the object to the second location of the receiver, wherein a ray-primitive interaction point at which the ray interacts with the object is located at a fourth location, and wherein the fourth location corresponds to a fixed position on the object at the third location;
performing, based on a result of performing the geometric computation, an electromagnetic computation to determine a first channel tap response;
receiving a second snapshot of the environment, wherein the second snapshot is associated with a second time, wherein the second snapshot indicates the set of primitives within the environment, and wherein the object is located at a fifth location within the environment;
determining a displacement associated with the object moving from the third location to the fifth location;
applying the displacement to the fourth location of the ray-primitive interaction point to determine a sixth location, wherein the sixth location corresponds to the fixed position on the object at the fifth location;
determining a total propagation distance associated with the NLOS path based on the fifth location and the sixth location;
determining a second channel tap response based on the total propagation distance associated with the NLOS path; and
outputting information associated with the second channel tap response.

2. The method of claim 1, further comprising:
determining a phase term based on the total propagation distance, wherein the second channel tap response is determined based on the phase term.

3. The method of claim 1, wherein one or more subsequent channel tap responses are determined based on the ray-primitive interaction point being located at the fixed position on the object.

4. The method of claim 1, wherein the electromagnetic computation is performed based on a determination that a change in a time-variant complex amplitude over a time period is less than a threshold.

5. The method of claim 1, wherein the electromagnetic computation is performed based on a determination that a change in a time-variant total quantity of paths over a time period is less than a threshold.

6. The method of claim 1, wherein the electromagnetic computation is performed based on a determination that a change in a tap location in a delay domain over a time period is less than a threshold.

7. The method of claim 6, further comprising:
determining that the change in the tap location in the delay domain over the time period is less than the threshold based on a delay resolution or a bandwidth associated with the ray traveling through the environment.

8. The method of claim 1, wherein the electromagnetic computation is performed based on a determination that a difference, over a time period, in an exponential term used to determine the first channel tap response is greater than a threshold.

9. The method of claim 1, wherein the ray corresponds to a wireless communication signal.

10. A device, comprising:
one or more memories; and
one or more processors, coupled to the one or more memories, configured to:
receive a first snapshot of an environment, wherein the first snapshot is associated with a first time, wherein the first snapshot indicates a set of primitives within the environment, and wherein the set of primitives includes a transmitter located at a first location within the environment, a receiver located at a second location within the environment, and an object located at a third location within the environment;
perform, based on the first snapshot, a geometric computation, to determine a plurality of paths associated with a ray traveling through the environment from the first location of the transmitter to the second location of the receiver, wherein the plurality of paths includes a non-line of sight (NLOS) path that extends from the first location of the transmitter to the third location of the object and from the third location of the object to the second location of the receiver, wherein a ray-primitive interaction point at which the ray interacts with the object is located at a fourth location, and wherein the fourth location corresponds to a fixed position on the object at the third location;
perform, based on a result of performing the geometric computation, an electromagnetic computation to determine a first channel tap response;
receive a second snapshot of the environment, wherein the second snapshot is associated with a second time, wherein the second snapshot indicates the set of primitives within the environment, and wherein the object is located at a fifth location within the environment;
determine a displacement associated with the object moving from the third location to the fifth location;
apply the displacement to the fourth location of the ray-primitive interaction point to determine a sixth location, wherein the sixth location corresponds to the fixed position on the object at the fifth location;
determine a total propagation distance associated with the NLOS path based on the fifth location and the sixth location;
determine a second channel tap response based on the total propagation distance associated with the NLOS path; and
output information associated with the second channel tap response.

11. The device of claim 10, wherein the one or more processors are further configured to:
determine a phase term based on the total propagation distance, wherein the second channel tap response is determined based on the phase term.

12. The device of claim 10, wherein one or more subsequent channel tap responses are determined based on the ray-primitive interaction point being located at the fixed position on the object.

13. The device of claim 10, wherein the electromagnetic computation is performed based on a determination that a change in a time-variant complex amplitude over a time period is less than a threshold.

14. The device of claim 10, wherein the electromagnetic computation is performed based on a determination that a change in a time-variant total quantity of paths over a time period is less than a threshold.

15. The device of claim 10, wherein the electromagnetic computation is performed based on a determination that a change in a tap location in a delay domain over a time period is less than a threshold.

16. The device of claim 15, wherein the one or more processors are further configured to:
determine that the change in the tap location in the delay domain over the time period is less than the threshold based on a delay resolution or a bandwidth associated with the ray traveling through the environment.

17. The device of claim 10, wherein the electromagnetic computation is performed based on a determination that a difference, over a time period, in an exponential term used to determine the first channel tap response is greater than a threshold.

18. The device of claim 10, wherein the ray corresponds to a wireless communication signal.

19. A non-transitory computer-readable medium storing a set of instructions, the set of instructions comprising:
one or more instructions that, when executed by one or more processors of a device, cause the device to:
receive a first snapshot of an environment, wherein the first snapshot is associated with a first time, wherein the first snapshot indicates a set of primitives within the environment, and wherein the set of primitives includes a transmitter located at a first location within the environment, a receiver located at a second location within the environment, and an object located at a third location within the environment;
perform, based on the first snapshot, a geometric computation, to determine a plurality of paths associated with a ray traveling through the environment from the first location of the transmitter to the second location of the receiver, wherein the plurality of paths includes a non-line of sight (NLOS) path that extends from the first location of the transmitter to the third location of the object and from the third location of the object to the second location of the receiver, wherein a ray-primitive interaction point at which the ray interacts with the object is located at a fourth location, and wherein the fourth location corresponds to a fixed position on the object at the third location;
perform, based on a result of performing the geometric computation, an electromagnetic computation to determine a first channel tap response;
receive a second snapshot of the environment, wherein the second snapshot is associated with a second time, wherein the second snapshot indicates the set of primitives within the environment, and wherein the object is located at a fifth location within the environment;
determine a displacement associated with the object moving from the third location to the fifth location;
apply the displacement to the fourth location of the ray-primitive interaction point to determine a sixth location, wherein the sixth location corresponds to the fixed position on the object at the fifth location;
determine a total propagation distance associated with the NLOS path based on the fifth location and the sixth location;
determine a second channel tap response based on the total propagation distance associated with the NLOS path; and
output information associated with the second channel tap response.

20. The non-transitory computer-readable medium of claim 19, wherein the one or more instructions further cause the device to:
determine a phase term based on the total propagation distance, wherein the second channel tap response is determined based on the phase term.
